(19) United States
(12) Patent Application Publication
(10) Pub. No.: US 2003/0152087 A1
(43) Pub. Date: Aug. 14, 2003

(54) Excess-port switch

(76) Inventors: Troy Alexander Shahoumian, Sunnyvale, CA (US); John Wilkes, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/068,883

(22) Filed: Feb. 11, 2002

(51) Int. Cl. H04L 12/28; H04L 12/56

(52) U.S. Cl. 370/401; 370/412

(57) ABSTRACT

An excess-port network switch includes a plurality of ports configured to receive and transmit data. The plurality of ports is adapted to have a configured throughput. The excess-port network switch also includes a switch fabric configured to route data between the plurality of ports, where the switch fabric is also configured to have a predetermined throughput being less than the total configured throughput of the plurality of ports.

### FIELD OF THE INVENTION

This invention relates generally to switches. In particular, the invention relates to a switch with an excess number of ports.

### DESCRIPTION OF THE RELATED ART

Network switches are widely used today. A conventional network switch is a network device that forwards units of data (packets) to their next destination across a wire, path or circuit.

In today's high performance networks, network switch designers typically design conventional network switches with full performance in mind. Specifically, network switch designers attempt to engineer for a worse case scenario where an internal switching mechanism of the network switch can support full bandwidth (e.g., wire speed) simultaneously for all the ports and between all port pairs.

However, in order to enable full performance, network switch designers may have to use the latest techniques in buffering, queue processing, etc. and the latest technologies in memory, busses, processors, etc. Accordingly, the implementation of full performance tends to increase the cost (e.g. the expense, physical space, etc.) of the network switch. For example, a conventional network switch with a large number of ports on the network switch typically has an internal switching mechanism to support the ports operating at wire speed. In that regard, the internal switching mechanism may have to account for the worse case scenario for the large number of ports and thus, increasing the cost of the internal switching mechanism. Moreover, and especially if the internal switching mechanism is a bus, the cost of the interface between the bus and each port contributes to the cost of the network switch because the interface has to be able to operate at the high speed needed by the bus, rather than the lower speed associated with the port.

Furthermore, another contributing factor to the cost of conventional network switches is ‘feature creep’, which is a tendency to incorporate more features such as a larger memory, faster processors, etc. There is a tendency for network switch designers to incorporate additional features to support the substantially high cost of the conventional network switches. For example, dynamic buffering, head-of-line unblocking schemes, etc., add complexity and therefore, additional costs to the conventional network switch. As an example of the cost differential, a 16-port FibreChannel switch is currently priced in a range of $20-30 k while a 64-port FibreChannel switch is currently priced in a range of $300-400 k. As a result of the high cost of high-port network switches, these network switches are not readily deployed in low-end solutions, or in Internet Data Centers (IDCs) where the flexibility of a network switch with many ports would be beneficial.

One approach in providing flexibility in wiring for low-end solutions is to design a network switch with ‘just-enough’ switch capacity to support the network performance requirements of a particular solution such as an IDC. Accordingly, the designed network switch may be used to interconnect the devices of the IDC in a number of configurations, where each configuration supports the network performance requirements. However, the designed network switch may have drawbacks and disadvantages. For example, as conditions change within the network, the system administrators may have to manually re-configure the network to respond to the changed conditions, which may change so rapidly and dynamically as to overwork the system administrators. Moreover, many data centers are configured such that physical access to the network devices is difficult.

Another approach in wiring low-end solutions and IDCs is to utilize patch panels. A patch panel serves as a sort of static switchboard using cables to interconnect computers within the network data center. Although patch panels provide flexibility in wiring, there are some drawbacks and hindrances. For instance, patch panels require an additional piece of hardware thereby incurring extra costs, i.e., physical space, expense, etc. Patch panels also typically require manual intervention to change their configuration, so they cannot be operated remotely. Furthermore, patch panels may not provide any graceful degradation of power consumption by the network switch. For example, patch panels typically do not provide the capability to power off a port if the port is malfunctioning or not used. Furthermore, a patch panel does not usually provide the capability to scale with the bandwidth of a network as the network upgrades its capacity.

### SUMMARY OF THE INVENTION

In accordance with an embodiment of the present invention, the present invention pertains to an excess-port network switch. The excess-port network switch includes a plurality of ports configured to receive and transmit data, where each port is configured to have a respective configured throughput. The excess-port network switch also includes a switch fabric configured to route the data between the plurality of ports and configured to have a predetermined throughput. The predetermined throughput is less than a total of the respective configured throughputs of the plurality of ports.

Another embodiment of the present invention relates to an excess-port network switch. The excess-port network switch includes a plurality of ports configured to receive and transmit data, where each port has a respective projected throughput. The excess-port network switch also includes a switch fabric configured to route the data between the plurality of ports and configured to have a predetermined throughput. The predetermined throughput is less than a total of the respective projected throughputs of the plurality of ports.

### BRIEF DESCRIPTION OF THE DRAWINGS

Various features and aspects of the present invention can be more fully appreciated with reference to the following detailed description of the present invention in connection with the accompanying figure, in which:

FIG. 1 illustrates an exemplary block diagram of an excess-port network switch in accordance with an embodiment of the present invention.

FIG. 2 illustrates an exemplary block diagram of another embodiment of the present invention.

### DETAILED DESCRIPTION OF A PREFERRED EMBODIMENT

For simplicity and illustrative purposes, the principles of the present invention are described by referring mainly to an exemplary embodiment of an excess-port network switch. However, one of ordinary skill in the art would readily recognize that the same principles are equally applicable to, and can be implemented in, all types of systems requiring flexible reconfiguration capability, and that any such variation does not depart from the true spirit and scope of the present invention. Moreover, in the following detailed description, references are made to the accompanying figures, which illustrate specific embodiments in which the present invention may be practiced. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

In accordance with an embodiment of the present invention, an excess-port network switch, which may be implemented in low-end solutions and IDCs, includes reconfiguration capabilities. More particularly, the excess-port network switch is configured to have a plurality (or number) of ports, e.g., N ports, each port having a throughput. In one embodiment of the present invention, each port may have a configured throughput, where each port is designed to operate at a designated rate or speed (e.g., wire speed of a supported protocol). Alternatively, in another embodiment of the present invention, each port may have a projected throughput, where a user or a network designer may configure each port to have a maximum rate or speed but the port may operate at lower rate or speed.

The excess-port network switch also includes a switch fabric configured to route data among the ports. The switch fabric is also configured to have a predetermined throughput, where the predetermined throughput of the switch fabric is deliberately designed to be less than a total projected throughput of the number of ports. Alternatively, the predetermined throughput of the switch fabric is designed to be less than a total configured throughput of the number of ports. For example, the excess-port switch may have sixty-four (64) ports and the switch fabric may support port speed switching for thirty (30) ports, i.e., a total projected throughput of the 30 ports or a total configured throughput of the 30 ports. Accordingly, since the switching fabric of the excess-port switch fabric is comparable to a smaller conventional network switch, the cost of the excess-port switch is less than the cost of a full-bandwidth N-port switch. Thus, the cost of establishing connectivity in a network data center can be achieved at a cost comparable to using low-port-count network switches that provide less connectivity.

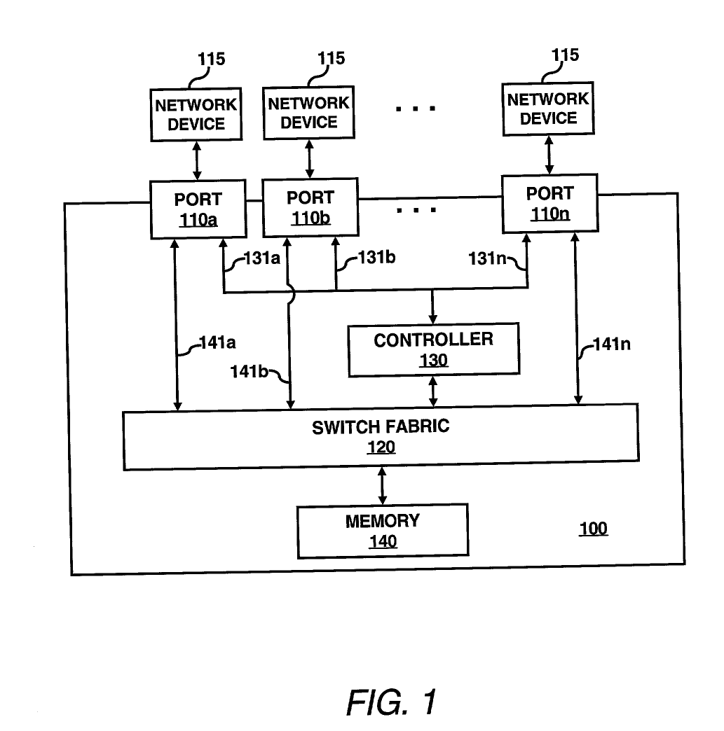

FIG. 1 illustrates an exemplary block diagram of an excess-port network switch 100 in accordance with the principles of the present invention. As shown in FIG. 1, the excess-port network switch 100 includes a plurality of ports 110a-110n, an internal switch fabric 120, a controller 130, and a memory 140. It should be readily apparent to those of ordinary skill in the art that the excess-port network switch 100 depicted in FIG. 1 represents a generalized schematic illustration and that other components may be added or existing components may be removed or modified without departing from the spirit or scope of the present invention.

The plurality of ports 110a-110n is configured to transmit and receive data (e.g., packets) from network devices 115 such as printers, servers, routers, other switches, and other network devices. The ports 110a-110n may be configured with buffers (not shown) for receiving and/or transmitting information. The ports 110a-110n may be further configured to transmit and receive data at a configured throughput such as the wire speed of the supported protocol (e.g., SCSI, Fibre Channel, Ethernet 802.3, etc.). Alternatively, the ports 110a-110n may be expected to transmit and receive data at a projected throughput, which may be a user-defined rate or speed.

The ports 110a-110n may be further configured to interface with the switch fabric 120 through a respective port interface 141a. . . 141n. The switch fabric 120 maybe configured to provide switching for the received packets at the ports 110a-110n. The switch fabric 120 may switch a received packet based on a source address and a destination address. The switch fabric 120 is also deliberately configured or designed to support the speed of an equivalent network switch with a smaller number of ports, or one with one or more slower-speed ports; that is, it is deliberately be engineered to operate at less than full performance (projected or configured throughput) for the number of ports attached to it. For example, the excess-port network switch 100 may have 32 ports and the switch fabric 120 may be designed to have throughput equivalent to the switch fabric in a conventional 8-port network switch.

The switch fabric 120 may use any of the many implementation techniques that are well known to those skilled in the art, including, but not limited to, one or more of a bus, shared memory, multiple point-to-point links, and a crossbar structure.

The switch fabric 120 may be further configured to interface with the controller 130. The controller 130 may be configured to control the overall operations of the corresponding excess-port network switch 100, including the programming of the switch fabric 120. The controller 130 may be implemented with a microprocessor, a micro-controller, a digital signal processor or other similar computing platform.

The controller 130 may configure the switch fabric 120 to operate as multiple ‘virtual switches’, i.e., configure a first set of ports 110a-110n as a first virtual switch, a second set of ports 110a-110n as a second virtual switch and so on.

The controller 130 may be further configured to provide enable/disable signals 131a. . . 131n to each of the ports 110a-110n of the excess-port network switch 100. Accordingly, a user may program the controller to enable/disable ports 110a. . . 110n individually or in groups. The enable/disable signals 131a. . . 131n may be control signals, power signals or other similar signals.

The controller 130 may be yet further configured with a control interface. This control interface may be accessed through a dedicated, external interface port (not shown), or it may be accessed via a logical interface port, achieved by treating the controller 130 as a destination or target for packets routed to the switch. The control interface may provide the capability for packet admission control software to selectively enable and/or disable ports 110a. . . 110n to optimize traffic flow based on network topologies. For example, the control interface may disable ports if the traffic through them is below a predetermined threshold, or below a threshold calculated by observing the overall traffic flow through the switch. (For example, a port may be disabled if it is carrying less than a predetermined fraction of the total traffic. Similarly, a port may be enabled if traffic through at least one other port is above such a threshold. Those skilled in the art will recognize that there are many ways in which such thresholds could be calculated, including both static (predetermined) and dynamic (on the fly) methods, and the examples included here should not be taken as limiting the scope of this invention in any way.

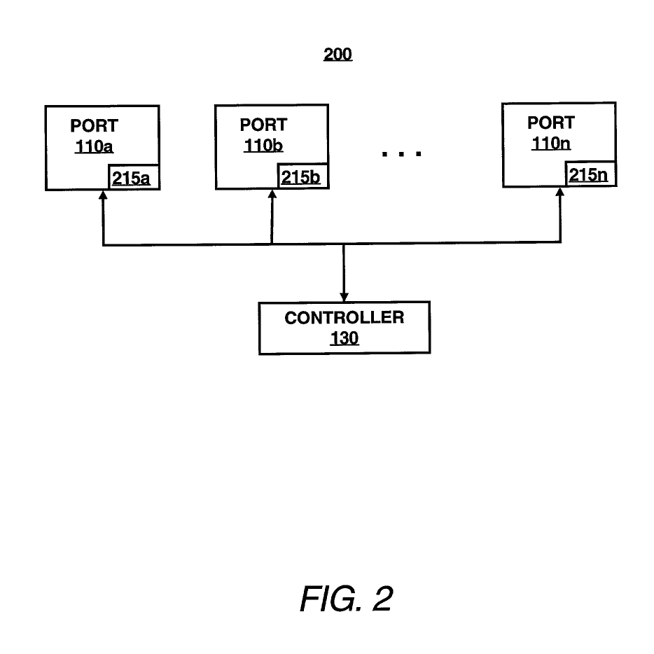

The control interface may also provide for the capability for internal or external network management software to selectively enable/disable ports 110a. . . 110n based on network failures. For example, the controller 130 may be configured to disable a port in response to an internal temperature of the port, which is illustrated in FIG. 2.

FIG. 2 illustrates an exemplary block diagram of another embodiment of the present invention. The network switch 200 of the second embodiment is similar to the excess-port switch 100 described hereinabove and thus only those features which are reasonably necessary for a complete understanding of the second embodiment is described hereinbelow.

As shown in FIG. 2, the ports 110a-110n are interfaced with the controller 130. Each of the ports, 110a-110n, may include a respective temperature sensor, 215a. . . 215n. The temperature sensors 215a. . . 215n may be implemented by a thermistor, a thermocouple or other similar temperature sensing device. The controller 130 may be configured to disable a selected port (e.g., 110a) by enabling the respective disable signal (e.g., 131a) in response to the respective temperature sensor (e.g., 215a) exceeding a defined temperature limit. Alternatively, the output of the temperature sensors, 215a. . . 215n, may be configured to be transmitted to an external network management system (not shown) through the control interface. The network management system may be configured to disable (or shut down) unnecessary operation at the system level.

Returning to FIG. 1, the memory 140 may be configured to provide temporary storage of the received packets at the ports 110a. . . 110n before they are forwarded to the destination ports. The memory 140 may be divided into buffers. The memory 140 may be implemented using memory technologies such as dual-port memories, content-addressable memories, etc.

According to an embodiment of the present invention, an excess-port network switch is utilized to increase the reconfiguration capabilities of network data centers. In particular, the excess-port network switch may be configured to have a plurality of ports, e.g., N ports. A switching fabric of the excess-port network switch may be configured to support the wire speed transfer for a fraction of the number of ports (a subset). Accordingly, a low cost network switch may be utilized in network data centers with the configuration capability of a high-ported network switch at a cost comparable to a low-ported network switch.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. More specifically, although the method of the present invention has been described by examples, the steps of the method may be performed in a different order than illustrated or simultaneously. Those skilled in the art will recognize that these and other variations are possible within the spirit and scope of the invention as defined in the following claims and their equivalents.

What is claimed is:

1. An excess-port network switch comprising:
a plurality of ports configured to receive and transmit data, wherein each port is adapted to have a respective configured throughput; and
a switch fabric configured to route said data between said plurality of ports and also configured to have a predetermined throughput, wherein said predetermined throughput is less than a total of said respective configured throughputs of said plurality of ports.

2. The switch according to claim 1, further comprising:
a controller configured to interface with said plurality of ports, wherein said controller is also configured to enable and disable at least one port of said plurality of ports.

3. The switch according to claim 2, further comprising:
a temperature sensor included in each port of said plurality of ports, wherein said controller is configured to disable said at least one port of said plurality of ports in response to said respective temperature sensor sensing a temperature exceeding a temperature limit.

4. The switch according to claim 2, wherein said controller is also configured to remove or apply power to at least one port of said plurality of ports.

5. The switch according to claim 2 wherein said controller is also configured to selectively enable and disable a sub-plurality of said plurality of ports in response to data packet traffic rate being compared to a threshold rate.

6. The switch according to claim 2, wherein said controller is configured to interface with said switch fabric.

7. The switch according to claim 6, wherein said controller is further configured to operate a sub-plurality of said plurality of ports as a zone.

8. The switch according to claim 1, wherein at least one port of said plurality of ports is configured to disable itself in response to an error condition.

9. The switch according to claim 8, wherein said error condition is an internal temperature of said at least one port exceeding a temperature limit.

10. An excess-port network switch comprising:
a plurality of ports configured to receive and transmit data, wherein each port of said plurality of ports has a respective projected throughput; and
a switch fabric configured to route said data between said plurality of ports and configured to have a predetermined throughput, wherein said predetermined throughput is less than a total of said respective projected throughputs of said plurality of ports.

11. The switch according to claim 10, further comprising:
a controller configured to interface with said plurality of ports, wherein said controller is configured to enable and disable at least one port of said plurality of ports.

12. The switch according to claim 11, further comprising:
a temperature sensor included in each port of said plurality of ports, wherein said controller is configured to disable said at least one port of said plurality of ports in response to respective temperature sensor sensing a temperature exceeding a temperature limit.

13. The switch according to claim 11, wherein said controller is configured to remove or apply power to at least one port of said plurality of ports.

14. The switch according to claim 11 wherein said controller is also configured to selectively enable and disable a sub-plurality of ports of said plurality of ports in response to data packet traffic.

15. The switch according to claim 11, wherein said controller is configured to interface with said switch fabric.

16. The switch according to claim 15, wherein said controller is further configured to operate a sub-plurality of said plurality of ports as a zone.

17. The switch according to claim 10, wherein at least one port of said plurality of ports is configured to disable itself in response to an error condition.

18. The switch according to claim 17, wherein said error condition is an internal temperature of said at least one port exceeding a temperature limit.
